(19) United States
(12) Patent Application Publication
(10) Pub. No.: US 2018/0155943 A1
(43) Pub. Date: Jun. 7, 2018

(54) SPECTATOR HALL AT RACETRACKS AND THE LIKE WITH LOUDSPEAKERS

(71) Applicant: QIRRASOUND TECHNOLOGIES EUROPE AB, Sollentuna (SE)

(72) Inventor: Thomas LAGÖ, Highland, UT (US)

(73) Assignee: QIRRASOUND TECHNOLOGIES EUROPE AB, Sollentuna (SE)

(21) Appl. No.: 15/643,971

(22) Filed: Jul. 7, 2017

Related U.S. Application Data
(60) Provisional application No. 62/359,434, filed on Jul. 7, 2016.

(51) Int. Cl. E04H 3/12; E04B 1/82; H04R 1/02

(52) U.S. Cl. CPC E04H 3/12; E04B 2001/8263; H04R 1/025; E04B 1/8209

(57) ABSTRACT

A spectator hall at racetracks includes a roof with an inner ceiling decreasing in height from the racetrack, an opening directed to the racetrack, a back wall, a number of seats arranged with increasing height from the racetrack, at least one loud speaker at the ceiling near the opening, and an invisible front wall covering the opening. The invisible front wall is made from a stable material like glass or acrylic polymer, and is mounted stiffly e g by stiffening bars.

The present invention relates to a spectator hall at racetracks and the like with loudspeakers. Most such halls have a high sound levels. The interesting fact is, that the design of common halls is such, that they will act like a “sound amplifier” or “microphone” which is obvious when looking at the enclosed FIG. 1. In this figure, a section of a common spectator hall is depicted. A race track is denoted by 1, a basic structure by 2. Supports 3, 4 and 5, carry a roof 6, inclining to a back wall 7. Seats 8, are arranged at increasing levels from the front 9, of the hall. There is a fence 10 between the racetrack 1 and the hall. One of more loudspeakers 11 is shown at the ceiling. It is obvious, that the sound from the racetrack will be amplified in the seating areas. The outside air has an acoustic impedance Z₁, and the inner impedance in the hall has impedance Z₂. The opening of the hall will act like an “impedance transformer” and allow the sound to easily travel into the seating area with little losses. Compare this to the exponential horn that is an impedance transformer for loudspeakers. Reciprocity rains and the “horn” will act like “a microphone” for the seating area. Also, the loud speaker up at the ceiling has challenges fighting the external sound that couples well to inner area, and will also project poorly due to the impedance difference. The impedance transformer is trying to “reject the sound” this sound, not allowing it. The complete design is wrong according to impedance theory in acoustics. Hence, the sound levels are very high in the seating area and it is almost impossible to hear what is being said by the speaker voices.

### BRIEF DESCRIPTION OF THE DRAWINGS

FIG. 1 is a section of a common spectator hall; and

FIG. 2 is a section of a spectator hall according to the present invention.

### DETAILED DESCRIPTION OF THE PREFERRED EMBODIMENTS

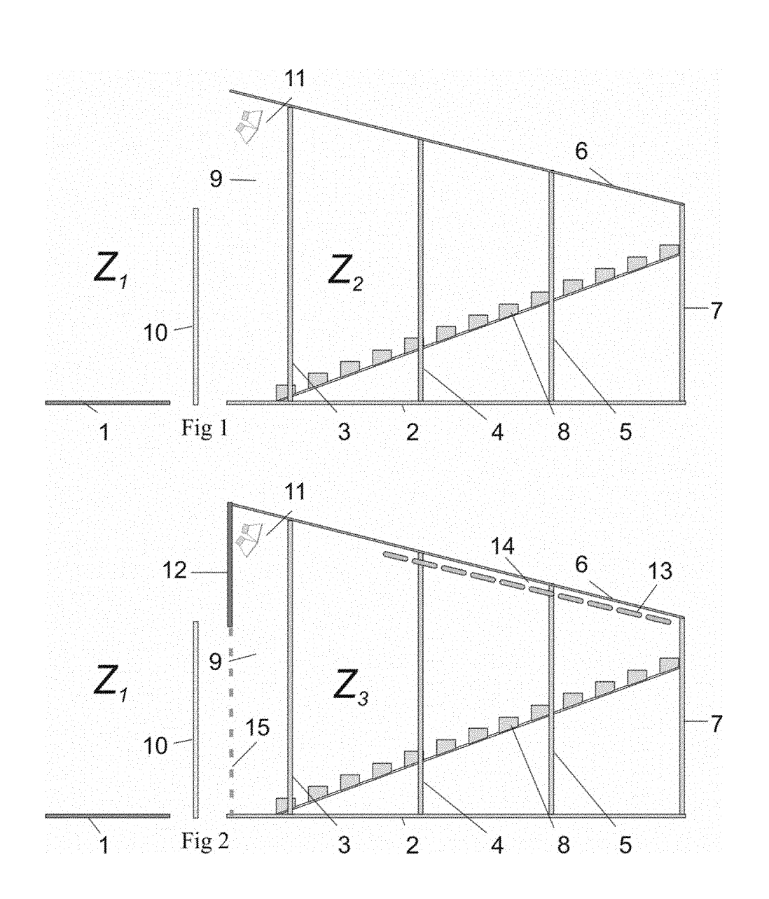

According to the invention, an improved design is shown in FIG. 2. In this reference numbers 1-11 show the same details as in FIG. 1. A transparent wall 12, preferably consisting of double glass or plastic, like acrylic polymer is mounted stiffly, e g by stiffening bars, making sure the wall does not radiate sound. This transparent wall should be mounted as low as possible, still giving the spectators a good view of the event. The incoming sound wave with an outside impedance Z₁ will have challenges going into the new inner impedance Z₃. The sound that will be reflected (R_{S}) in this “invisible wall,” created by the wall 12, is given by:

R_{S}=(Z₁−Z₃)/Z₁+Z₃)

Since the impedance difference is rather large between Z₁ and Z₃ due to the arrangement, the sound loose energy (a large part is reflected) when travelling into the seating area. This will create a substantial damping by itself and will help decrease the sound exposure on the visitors from the outside sound.

A further improvement of the spectator hall according to the invention is to arrange some damping material 13 at the inner ceiling 14, about ⅔ of the ceiling length from the back wall 7. Preferably absorption panels shall be mounted separated from each other with some air space from the ceiling, 2-5 inches is a good choice. This arrangement will further change the impedance for Z₃, and will also minimize the reflections and sound built up inside the seating area.

A further improvement is to mount loudspeakers 11 at the limit between the wall 12, and the ceiling (14). This will project the sound and create a “horn” that will amplify the sound inside the seating area, and the impedance transformer is now pointing in the correct direction.

The combined improvements will help creating a much better intelligibility and lower the harmful sound exposure to spectators. Today, the situation is both terrible and harmful. The solution is rather low cost and can be retrofitted and implemented at most race spectator seating areas and other similar venues.

1. A spectator hall at racetracks, comprising:
a roof with an inner ceiling decreasing in height from the racetrack;
an opening directed to the racetrack;
a back wall;
a number of seats arranged with increasing height from the racetrack;
at least one loud speaker at the ceiling near the opening; and
an invisible front wall covering the opening, said invisible front wall being made from a stable material and being mounted stiffly.

2. The spectator hall at racetracks according to claim 1, wherein damping material is arranged at the inner ceiling.

3. The spectator hall at racetracks according to claim 2, wherein the damping material covers about ⅔ of the ceiling length from the back wall.

4. The spectator hall at racetracks according to claim 3, wherein absorption panels are mounted separated from each other with some air space from the ceiling.

5. The spectator hall at racetracks according to claim 1, wherein loudspeakers are mounted at the limit between the wall and the ceiling.

6. The spectator hall at racetracks according to claim 2, wherein loudspeakers are mounted at the limit between the wall and the ceiling.

7. The spectator hall at racetracks according to claim 3, wherein loudspeakers are mounted at the limit between the wall and the ceiling.

8. The spectator hall at racetracks according to claim 4, wherein loudspeakers are mounted at the limit between the wall and the ceiling.

9. The spectator hall at racetracks according to claim 1, wherein said invisible front wall is made from glass or acrylic polymer and is mounted stiffly by stiffening bars.

10. The spectator hall at racetracks according to claim 4, wherein said air space from the ceiling is 2-5 inches.
